(19) United States
(12) Patent Application Publication
(10) Pub. No.: US 2016/0277750 A1
(43) Pub. Date: Sep. 22, 2016

(54) METHOD OF PROCESSING IMAGE AND ELECTRONIC DEVICE THEREOF

(71) Applicant: Samsung Electronics Co., Ltd., Suwon-si (KR)

(72) Inventors: Sungoh KIM, Suwon-si (KR); Hyunhee PARK, Seoul (KR); Yongman LEE, Seongnam-si (KR); Kwangyoung KIM, Yongin-si (KR); Kwang-Tai KIM, Suwon-si (KR); Soo-Hyung KIM, Hwaseong-si (KR); Hyunsoo KIM, Yongin-si (KR); Eun-Seok RYU, Seoul (KR); Kihuk LEE, Suwon-si (KR); Jinhong JEONG, Yongin-si (KR)

(21) Appl. No.: 15/075,926

(22) Filed: Mar. 21, 2016

(30) Foreign Application Priority Data
Mar. 20, 2015 (KR) 10-2015-0039134

(51) Int. Cl. H04N 19/186; H04N 19/172; H04N 19/14; G06T 3/40; G06K 9/46

(52) U.S. Cl. CPC H04N 19/186; G06T 3/40; G06K 9/4604; H04N 19/14; H04N 19/172

(57) ABSTRACT

An apparatus and a method for efficiently processing an image in an electronic device are provided. A method of operating an electronic device includes acquiring an image, extracting object configuration information on the image, down scaling the image, and storing the down scaled image and the object configuration information. Other embodiments may be possible.

### CROSS-REFERENCE TO RELATED APPLICATION(S)

This application claims the benfit under 35 U.S.C. §119(a) of a Korean patent application filed on Mar. 20, 2015 in the Korean Intellectual Property Office and assigned Serial No. 10-2015-0039134, the entire disclosure of which is hereby incorporated by reference.

### TECHNICAL FIELD

The present disclosure relates to an apparatus and a method for processing an image in an electronic device.

### BACKGROUND

With the development of information and communication technologies and semiconductor technologies, various types of electronic devices have developed into multimedia devices that provide various multimedia services. For example, portable electronic devices may provide diverse multimedia services such as broadcast services, wireless Internet services, camera services, and music reproduction services.

The electronic device may provide the camera service that acquires various images through at least one image sensor.

The above information is presented as background information only to assist with an understanding of the present disclosure. No determination has been made, and no assertion is made, as to whether any of the above might be applicable as prior art with regard to the present disclosure.

### SUMMARY

When a camera service is provided through an electronic device, the electronic device may down scale an image (for example, a raw image) acquired through an image sensor, perform image signal processing (ISP) on the down scaled image, and display the image on a display. Additionally, the electronic device may perform the ISP on the image acquired through the image sensor for image capturing and temporarily store the image in a frame buffer.

Accordingly, the electronic device performs different ISP on the same image depending on the purpose of use, thereby generating a load as a result of the image processing. Further, when capturing the image, the electronic device may store the large capacity image acquired through the image sensor, which requires a large amount of storage space.

Aspects of the present disclosure are to address at least the above-mentioned problems and/or disadvantages and to provide at least the advantages described below. Accordingly, an aspect of the present disclosure is to provide an apparatus and a method for reducing an image processing load in an electronic device.

Another aspect of the present disclosure is to provide an apparatus and a method for reducing consumption of memory resources due to image storage in an electronic device.

In accordance with an aspect of the present disclosure, a method of operating an electronic device is provided. The method includes acquiring an image, extracting object configuration information on the image, down scaling the image, and storing the down scaled image and the object configuration information.

In accordance with another aspect of the present disclosure, an electronic device is provided. The electronic device includes a memory configured to store an image and information related to the image, and a processor configured to acquire the image, extract object configuration information on the image, down scale the image, and store the down scaled image and the object configuration information in the memory.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain emodiments of the present disclosure will be more apparent from the following description taken in conjunction with the accompanying drawings, in which:

FIG. 1 is a block diagram of an electronic device according to an embodiment of the present disclosure;

FIG. 2 is a block diagram of a processor according to various embodiments of the present disclosure;

FIG. 3 is a detailed block diagram of an electronic device according to various embodiments of the present disclosure;

FIG. 4 is a flowchart illustrating an operation for converting an image in an electronic device according to various embodiments of the present disclosure;

FIG. 5 is a flowchart illustrating an operation for converting an image acquired through a camera in an electronic device according to various embodiments of the present disclosure;

FIG. 6 is a flowchart illustrating an operation for converting an image acquired through a camera in an electronic device according to various embodiments of the present disclosure;

FIG. 7 is a flowchart illustrating an operation for generating a captured image in an electronic device according to various embodiments of the present disclosure;

FIG. 8 is a flowchart illustrating an operation for generating a captured image in an electronic device according to various embodiments of the present disclosure; and

FIG. 9 is a flowchart illustrating an operation for displaying a captured image in an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure may have various embodiments, and modifications and changes may be made therein. Therefore, the present disclosure will be described with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit the addition of one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “ adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a central processing unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various embodiments of the present disclosure may be a device. For example, the electronic device according to various embodiments of the present disclosure may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer 3 (MP3) player, a mobile medical device, a camera, a power bank, or a wearable device (e.g., a head-mount-device (HMD), electronic glasses, electronic clothing, an electronic bracelet, an electronic necklace, an electronic appcessory, an electronic tattoo, a smart mirror, or a smart watch).

In other embodiments, an electronic device may be a home appliance. For example, of such appliances may include at least one of a television (TV), a digital video disk (DVD) player, an audio component, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV), a game console (e.g., Xbox® PlayStation®), an electronic dictionary, an electronic key, a camcorder, or an electronic frame.

In other embodiments, an electronic device may include at least one of a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine), a navigation device, a global navigation satellite system (GNSS), an event data recorder (EDR), a flight data recorder (FDR), an in-vehicle infotainment device, an electronic equipment for a ship (e.g., ship navigation equipment and/or a gyrocompass), an avionics equipment, a security equipment, a head unit for vehicle, an industrial or home robot, an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like).

In certain embodiments, an electronic device may include at least one of a piece of furniture or a building/structure, an electronic board, an electronic signature receiving device, a projector, and various measuring instruments (e.g., a water meter, an electricity meter, a gas meter, or a wave meter). Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

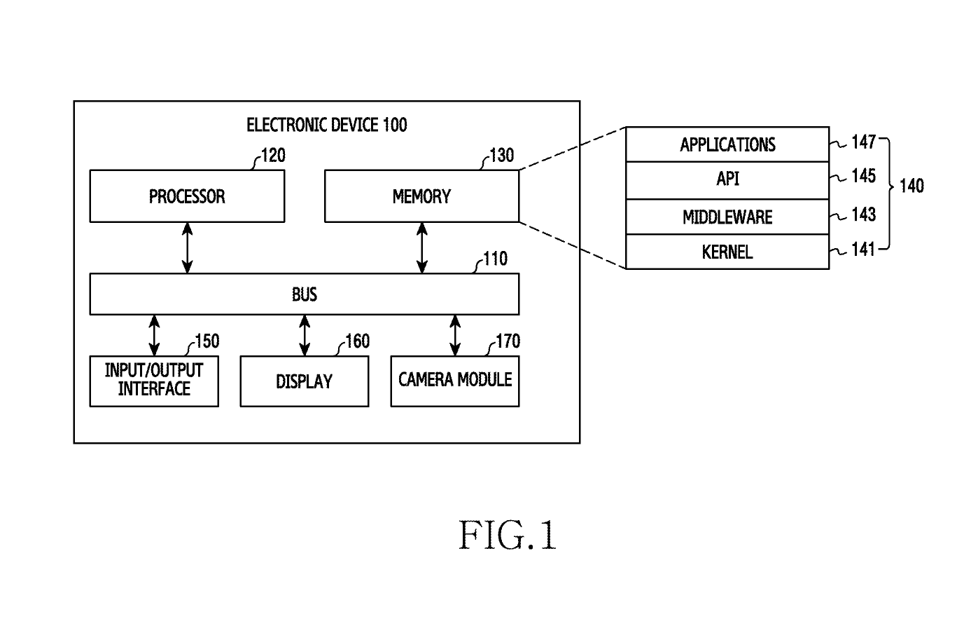

FIG. 1 is a block diagram of an electronic device according to an embodiment of the present disclosure.

Referring to FIG.1, an electronic device 100, according to the various embodiments, will be described below. The electronic device 100 may include a bus 110, a processor 120 (e.g., including processing circuitry), a memory 130, an input/output interface 150 (e.g., including input/output circuitry), a display 160 (e.g., including a display panel and display circuitry), and a camera module 170 (e.g., including communication circuitry). In an embodiment, at least one of the elements of the electronic device 100 may be omitted, or other elements may be additionally included in the electronic device 100.

The bus 110 may include, for example, a circuit that interconnects the elements 110 to 170 and transfers communication (e.g., a control message and/or data) between the elements.

The processor 120 may include one or more of a CPU, an AP, an ISP, and a communication processor (CP). The processor 120 may, for example, perform an operation or data processing on control and/or communication of at least one other element of the electronic device 100.

The processor 120 may store a down scaled image (raw image) for image capturing in a frame buffer. For example, the frame buffer may be included in the processor 120 or the memory 130 or may be configured as a separate module.

According to an embodiment of the present disclosure, the processor 120 may extract configuration information on objects included in the raw image acquired through the camera module 170 and down scale the corresponding image. For example, the processor 120 may down scale the image in accordance with a display resolution of the display 160. The processor 120 may perform image signal processing (ISP) on the down scaled image and store the image in the frame buffer. For example, the processor 120 may store the image signal-processed image and object configuration information on the corresponding image in the frame buffer. For example, the processor 120 may encode (or compress) the image signal-processed image and store the image in the frame buffer. In this case, the electronic device may determine whether to encode the image based on the complexity of the down scaled image. When it is determined to not encode the image, the electronic device may store the down scaled image in the frame buffer without the encoding. Additionally, the processor 120 may control the display 160 to display the image signal-processed image (for example, preview image). The object configuration information may include edge information indicating edges of the object included in the image. Additionally, the object configuration information may further include a depth map of the image.

According to an embodiment of the present disclosure, the processor 120 may perform the ISP on the raw image acquired through the camera module 170. The processor 120 may extract configuration information (for example, edge information) on objects included in the image signal-processed image, down scale the corresponding image, and store the image in the frame buffer. For example, the processor 120 may store the down scaled image and object configuration information on the corresponding image in the frame buffer. For example, the processor 120 may encode the down scaled image and store the image in the frame buffer. Additionally, the processor 120 may control the display 160 to display the down scaled image (for example, preview image).

According to an embodiment of the present disclosure, the processor 120 may extract configuration information (for example, edge information) on objects included in an image (image in a YUV or red/green/blue (RGB) format) received from an external device (for example, another electronic device or a server), down scale the corresponding image, and store the image in the frame buffer. For example, the processor 120 may store the down scaled image and object configuration information on the corresponding image in the frame buffer. For example, the processor 120 may encode the down scaled image and store the image in the frame buffer. Additionally, the processor 120 may control the display 160 to display the down scaled image (for example, preview image).

The processor 120 may generate a captured image by using the down scaled image stored in the frame buffer.

According to an embodiment of the present disclosure, the processor 120 may extract an image corresponding to a capture event from the frame buffer. For example, when an encoded image is stored in the frame buffer, the processor 120 may extract the image corresponding to the capture event and decode the image. The processor 120 may up scale the image corresponding to the capture event and reconstruct the image by using object configuration information on the corresponding image. The processor 120 may encode the reconstructed image into a reference format (for example, joint photographic coding experts Group (JPEG), high efficiency video coding (HEVC), H.264, or the like) for storing the captured image and store the image in the memory 130. Additionally, the processor 120 may store the object configuration information in the memory 130 such that the object configuration information is mapped to the corresponding captured image to perform additional image processing on the captured image.

According to an embodiment of the present disclosure, the processor 120 may extract an image corresponding to a capture event from the frame buffer. For example, when an encoded image is stored in the frame buffer, the processor 120 may extract the image corresponding to the capture event and decode the image. The processor 120 may encode the image corresponding to the capture event into a reference format (for example, JPEG, HEVC, H.264, or the like) for storing the captured image and store the image in the memory 130 such that the image is mapped to the object configuration information.

The memory 130 may include a volatile memory and/or a non-volatile memory. The memory 130 may store, for example, instructions or data (e.g. motion pattern information, motion data) relevant to at least one other element of the electronic device 100. According to an embodiment, the memory 130 may store software and/or a program 140. For example, the program may include a kernel 141, middleware 143, an application programming interface (API) 145, and an application (or “application program”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented by the other programs (e.g., the middleware 143, the API 145, or the application 147). Furthermore, the kernel 141 may provide an interface through which the middleware 143, the API 145, or the application 147 may access the individual elements of the electronic device 100 to control or manage the system resources.

The middleware 143, for example, may function as an intermediary for allowing the API 145 or the application 147 to communicate with the kernel 141 to exchange data.

In addition, the middleware 143 may process one or more task requests received from the application 147 according to priorities thereof. For example, the middleware 143 may assign priorities for using the system resources (e.g., the bus 110, the processor 120, the memory 130, or the like) of the electronic device 100, to at least one of the application 147. For example, the middleware 143 may perform scheduling or load balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 100. Furthermore, the input/output interface 150 may output the instructions or data received from the other element(s) of the electronic device 100 to the user or another external device.

Examples of the display 160 may include a liquid crystal display (LCD), a light-emitting diode (LED) display, an organic light-emitting diode (OLED) display, a micro electro mechanical systems (MEMS) display, and an electronic paper display. The display 160, for example, may display various types of content (e.g., text, images, videos, icons, or symbols) to the user. The display 160 may include a touch screen and receive, for example, a touch, gesture, proximity, or hovering input using an electronic pen or the user's body part.

According to an embodiment of the present disclosure, the display 160 may display at least one image (for example, preview image) based on a control of the processor 120.

The camera module 170 may provide a raw image of a subject acquired through at least one image sensor functionally connected to the electronic device 100 to the processor 120.

The electronic device 100 may further include a communication interface (not shown) capable of establishing a communication with an external device (for example, another electronic device or the server). For example, the communication interface may be connected to a network through wireless communication or wired communication and communicate with the external device. For example, the wireless communication may include at least one of, for example, Wi-Fi, Bluetooth, near-field communication (NFC), a bluetooth low energy (BLE), and a global positioning system (GPS) as a short range communication protocol. For example, the wireless communication may use at least one of, for example, long term evolution (LTE), LTE-advance (LTE-A), code division multiple access (CDMA), wideband CDMA (WCDMA), universal mobile telecommunications System (UMTS), WiBro (Wireless Broadband), and global system for mobile communications (GSM), as a cellular communication protocol. For example, the wired communication may include, for example, at least one of a universal serial bus (USB), a high definition multimedia interface (HDMI), recommended standard 332 (RS-332), and a plain old telephone service (POTS). The network may include a telecommunication network, for example, at least one of a computer network (e.g., a LAN or a WAN), the Internet, and a telephone network.

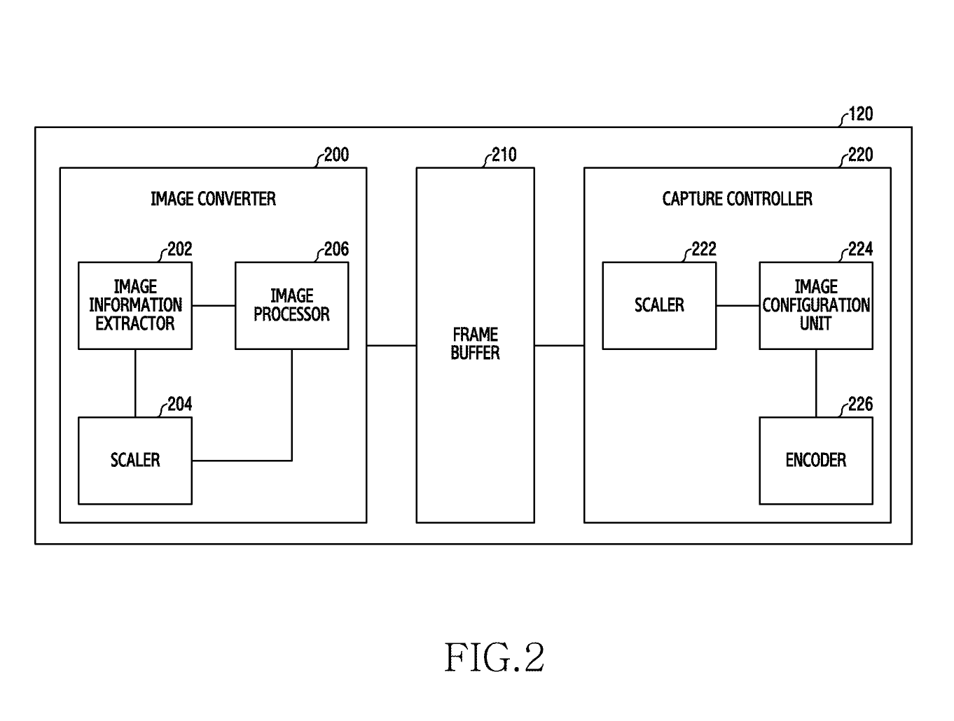

FIG. 2 is a block diagram of a processor according to various embodiments of the present disclosure.

Referring to FIG. 2, the processor 120 may include an image converter 200, a frame buffer 210, and a capture controller 220.

According to an embodiment of the present disclosure, the image converter 200 may store a down scaled image (raw image) for image capturing in the frame buffer 210. For example, the image converter 200 may include an image information extractor 202, a scaler 204, and an image processor 206.

According to an embodiment of the present disclosure, the image information extractor 202 may extract configuration information (for example, edge information) on objects included in the image (raw image) acquired through the camera module 170. For example, the image information extractor 202 may blur the raw image acquired through the camera module 170, extract a difference between the original image and the blurred image, and extract object configuration information on the corresponding image. The scaler 204 may down scale the image (for example, blurred image or original image) received from the image information extractor 202. For example, the scaler 204 may down scale the image in accordance with a display resolution of the display 160. The image processor 206 may perform ISP on the image down scaled by the scaler 204 and store the image in the frame buffer 210. Additionally, the image processor 206 may provide the down scaled image (for example, preview image) to the display 160.

According to an embodiment of the present disclosure, the image processor 206 may perform the ISP on the raw image acquired through the camera module 170. The image information extractor 202 may extract configuration information on objects included in the image (for example, image in a YUV or RGB format) which has passed through the ISP by the image processor 206. For example, the image information extractor 202 may blur the image signal-processed image, extract a difference between the image signal-processed image and the blurred image, and extract object configuration information on the corresponding image. The scaler 204 may down scale the image (for example, blurred image or image signal-processed image) received from the image information extractor 202 and store the image in the frame buffer 210. Additionally, the scaler 204 may provide the down scaled image (for example, preview image) to the display 160.

According to an embodiment of the present disclosure, the image information extractor 202 may extract configuration information (for example, edge information) on objects included in the image (image in the YUV or RGB format) received from an external device (for example, another electronic device or a server). For example, the image information extractor 202 may blur the image received from the external device, extract a difference between the original image (for example, the image received from the external device) and the blurred image, and extract object configuration information on the corresponding image. The scaler 204 may down scale the image (for example, blurred image or image signal-processed image) received from the image information extractor 202. Additionally, the scaler 204 may provide the down scaled image (for example, preview image) to the display 160.

According to an embodiment of the present disclosure, the frame buffer 210 may temporarily store the image down scaled by the image converter 200. For example, the frame buffer 210 may store the image (for example, down scaled image) received from the image converter 200 and the object configuration information on the corresponding image. For example, the frame buffer 210 may encode the down scaled image received from the image converter 200 and store the encoded image. For example, the frame buffer 210 may determine whether to encode the image based on the complexity of the down scaled image received from the image converter 200. When it is determined to not encode the image, the frame buffer 210 may store the down scaled image without the encoding. For example, the frame buffer 210 may be configured as a ring buffer.

According to an embodiment of the present disclosure, the capture controller 220 may generate a captured image by using the down scaled image stored in the frame buffer 210. For example, the capture controller 220 may include a scaler 222, an image configuration unit 224, and an encoder 226.

According to an embodiment of the present disclosure, the scaler 222 may extract an image corresponding to a capture event from the frame buffer 210 and up scale the image. For example, when an encoded image is stored in the frame buffer 210, the scaler 222 may extract the image corresponding to the capture event, and decode and up scale the image. The image configuration unit 224 may reconstruct the image by using object configuration information on the image corresponding to the capture event. The encoder 226 may encode the image reconstructed by the image configuration unit 224 into a reference format (for example, JPEG, HEVC, H.264, or the like) for storing the captured image and store the image in the memory 130. Additionally, the memory 130 may store the object configuration information such that the object configuration information is mapped to the corresponding captured image to perform additional image processing on the captured image.

According to an embodiment of the present disclosure, the encoder 226 may extract the image corresponding to the captured image from the frame buffer 210, encode the image into a reference format (for example, JPEG, HEVC, H.264, or the like) for storing the captured image, and store the image in the memory 130. For example, when an encoded image is stored in the frame buffer 210, the encoder 226 may extract the image corresponding to the capture event, and decode and encode the image. The memory 130 may store the object configuration information mapped to the image corresponding to the capture event.

In FIG. 2, the processor 120 may include the frame buffer 210.

According to various embodiments of the present disclosure, the frame buffer 210 may be included in the memory 130 or may be configured as a separate module.

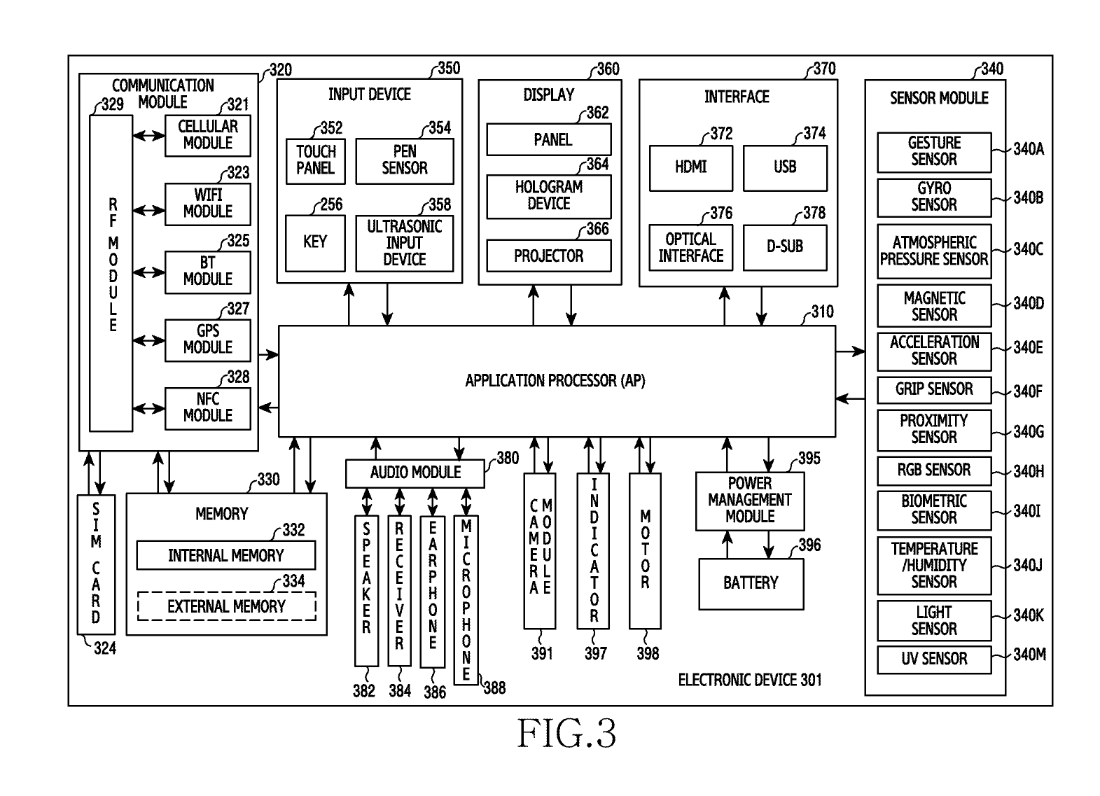

FIG. 3 is a detailed block diagram of an electronic device according to various embodiments of the present disclosure. Hereinafter, an electronic device 301 may constitute, for example, all or a part of the electronic device 100 illustrated in FIG. 1.

Referring to FIG. 3, the electronic device 301 may include at least one AP 310, a communication module 320, a subscriber identification module (SIM) card 324, a memory 330, a sensor module 340, an input device 350, a display 360, an interface 370, an audio module 380, a camera module 391, a power management module 395, a battery 396, an indicator 397, or a motor 398.

The AP 310 may control a plurality of hardware or software elements connected to the AP 310 by driving an OS or an application program. The AP 310 may process various types of data including multimedia data or perform calculations.

The communication module 320 may perform data transmission/reception in communication between different electronic devices connected to the electronic device 301 (for example, the electronic device 100) through a network. According to an embodiment, the communication module 320 may include a cellular module 321, a Wi-Fi module 323, a BlueTooth (BT) module 325, a GPS module 327, an NFC module 328, and a Radio Frequency (RF) module 329.

The cellular module 321 may provide a voice call, a video call, a text message service, or an Internet service through a communication network (for example, LTE, LTE-A, CDMA, WCDMA, UMTS, WiBro, or GSM).

According to an embodiment of the present disclosure, the cellular module 321 may include a CP.

According to an embodiment of the present disclosure, the AP 310 may store a down scaled image (raw image) for image capturing in the frame buffer 210. For example, the frame buffer may be included in the AP 310 or the memory 330 or may be configured as a separate module.

According to an embodiment of the present disclosure, the AP 310 may generate a captured image by using the down scaled image stored in the frame buffer.

Each of the Wi-Fi module 323, the BT module 325, the GPS module 327, and the NFC module 328 may include, for example, a processor for processing data transmitted/received through the corresponding module.

The RF module 329 may transmit and receive data, for example, RF signals.

The SIM card 324 may be a card that includes a SIM and may be inserted into a slot formed in a predetermined location of the electronic device. The SIM card 324 may include unique identification information (for example, an integrated circuit card identifier (ICCID)) or subscriber information (for example, an international mobile subscriber identity (IMSI)).

The memory 330 may include an internal memory 332 or an external memory 334.

The sensor module 340 may measure a physical quantity or sense an operational state of the electronic device 301 and may convert the measured or sensed information to an electric signal. The sensor module 340 may include at least one of, for example, a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (for example, a RGB) sensor), a biometric sensor 340I, a temperature/humidity sensor 340J, an illumination sensor 340K, and an ultraviolet (UV) sensor 340M. Additionally or alternatively, the sensor module 340 may, for example, include an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor (not illustrated), an iris sensor (not illustrated), a fingerprint sensor (not illustrated), and the like. The sensor module 340 may further include a control circuit for controlling one or more sensors included therein.

The input device 350 may include a touch panel 352, a (digital) pen sensor 354, a key 356, or an ultrasonic input electronic device 358.

The display 360 (for example, the display 160) may include a panel 362, a hologram device 364, or a projector 366.

The interface 370 may include, for example, a HDMI 372, a USB 374, an optical interface 376, and a D-subminiature (D-sub) 378.

The audio module 380 may convert a sound and an electrical signal, and vice versa. The audio module 380 may process sound information that is input or output through, for example, a speaker 382, a receiver 384, earphones 386, a microphone 388, or the like.

The camera module 391 may photograph a still image and a dynamic image.

The power management module 395 may manage power of the electronic device 301.

The indicator 397 may display a specific state, such as a booting state, a message state, a charging state, of the electronic device 301 or a part of the electronic device 310 (for example, the AP 310).

The motor 398 may convert an electrical signal into a mechanical vibration.

Each of the above described elements of the electronic device according to various embodiments of the present disclosure may be formed of one or more components, and the name of a corresponding element may vary according to the type of an electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

According to various embodiments of the present disclosure, an electronic device may include a memory configured to store an image and information related to the image, and a processor configured to acquire an image, extract object configuration information on the image, down scale the image, and store the down scaled image and the object configuration information in the memory.

According to various embodiments of the present disclosure, the processor may be further configured to perform ISP on the down scaled image and to store the image signal-processed down scaled image and the object configuration information in the memory.

According to various embodiments of the present disclosure, the processor may be further configured to perform ISP on the image and extract object configuration information on the image signal-processed image.

According to various embodiments of the present disclosure, the processor may be further configured to extract edge information on the image or object configuration information including edge information and a depth map.

According to various embodiments of the present disclosure, the processor may be further configured to determine whether to encode the down scaled image based on a complexity of the down scaled image, encode the down scaled image and store the encoded image in a buffer of the memory in response to the determination to encode the down scaled image, and store the down scaled image in the buffer of the electronic device in response to the determination to not encode the down scaled image.

According to various embodiments of the present disclosure, the processor may be further configured to generate a captured image by using the down scaled image stored in the memory in response to a capture event.

According to various embodiments of the present disclosure, the processor may be further configured to extract an image corresponding to the capture event among the down scaled images stored in the memory in response to the capture event, up scale the extracted image, reconstruct the image by using the up scaled image and object configuration information on the image corresponding to the capture event, generate a captured image by encoding the reconstructed image into a reference format, and store the captured image in the memory.

According to various embodiments of the present disclosure, the processor may be further configured to add the object configuration information on the image corresponding to the capture event to an expanded field of the captured image and store the captured image.

According to various embodiments of the present disclosure, the processor may be further configured to extract an image corresponding to the capture event among the stored down scaled images in response to the capture event, generate a captured image by encoding the extracted image into a reference format, and store the captured image and object configuration information on the captured image in the memory.

According to various embodiments of the present disclosure, the memory may be further configured to add object configuration information on the captured image to an expanded field of the captured image and store the captured image.

According to various embodiments of the present disclosure, the electronic device may further include a display configured to display information, wherein the processor may be further configured to extract a captured image corresponding to a display event among the captured images stored in the memory in response to the display event, reconstruct the captured image by using the extracted captured image and object configuration information on the captured image, and display the reconstructed captured image on the display.

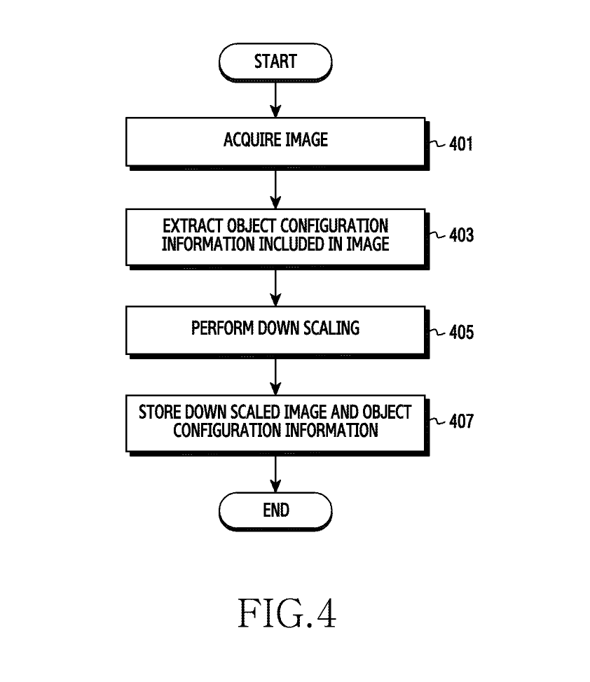

FIG. 4 is a flowchart illustrating an operation for converting an image in an electronic device according to various embodiments of the present disclosure.

Referring to FIG. 4, in operation 401, the electronic device (for example, the electronic device 100 of FIG. 1 or the electronic device 301 of FIG. 3) may acquire an original image (for example, image signal-processed image). For example, the electronic device may receive the original image (for example, image in the YUV or RGB format) from an external device.

In operation 403, the electronic device may extract configuration information on objects (for example, edge information) included in the original image. For example, the electronic device may blur the original image. The electronic device may extract edge information on the original image by extracting a difference between the original image and the blurred image. Additionally, the electronic device may extract a depth map of the original image.

In operation 405, the electronic device may down scale the image (for example, the original image or the blurred image). For example, the electronic device may reduce a size (for example, resolution) of the image in accordance with a display resolution of the display 160.

In operation 407, the electronic device may store the down scaled image and the object configuration information on the corresponding image in a frame buffer (for example, the frame buffer 210). For example, the electronic device may encode at least one of the down scaled image and the object configuration information and store the down scaled image or the object configuration information in the frame buffer. For example, the electronic device may determine whether to encode the down scaled image based on the complexity of the down scaled image. When it is determined to not encode the image, the electronic device may store the down scaled image in the frame buffer without the encoding.

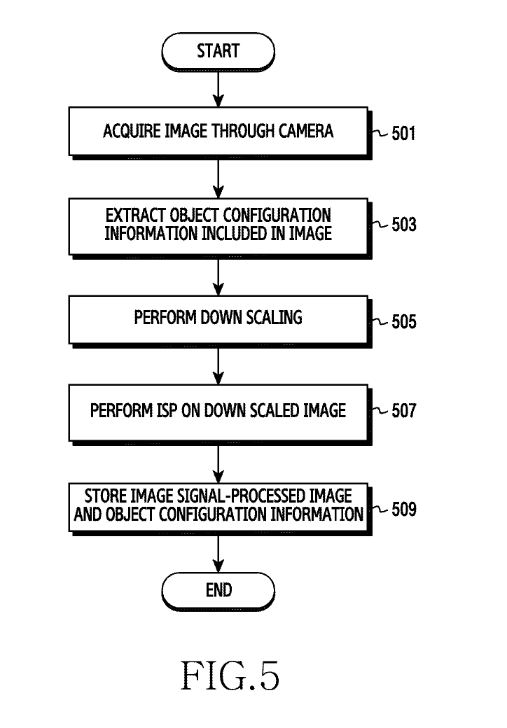

FIG. 5 is a flowchart illustrating an operation for converting an image acquired through a camera in an electronic device according to various embodiments of the present disclosure.

Referring to FIG. 5, in operation 501, the electronic device (for example, the electronic device 100 of FIG. 1 or the electronic device 301 of FIG. 3) may acquire an original image (for example, raw image) through a camera module (for example, the camera module 170). For example, the electronic device may acquire the original image (for example, raw image) by using at least one image sensor functionally connected to the electronic device.

In operation 503, the electronic device may extract configuration information (for example, edge information) on objects included in the original image. Additionally, the electronic device may extract a depth map of the original image.

In operation 505, the electronic device may down scale the image (for example, the original image or the image converted to extract the object configuration information). For example, the electronic device may reduce a size (for example, resolution) of the image in accordance with a resolution of the display 160.

In operation 507, the electronic device may perform ISP on the down scaled image. For example, the electronic device may perform the ISP to improve picture quality corresponding to at least one of noise correction, gamma correction, color filter array interpolation, color matrix, color correction, and color enhancement on the down scaled image. The electronic device may generate the image in the YUV or RGB format by encoding image data generated through the ISP.

In operation 509, the electronic device may store the image signal-processed image and the object configuration information on the corresponding image in a frame buffer (for example, the frame buffer 210). For example, the electronic device may encode at least one of the image signal-processed image and the object configuration information and store the image signal-processed image or the object configuration information in the frame buffer. For example, the electronic device may determine whether to encode the image signal-processed image based on the complexity of the image signal-processed image.

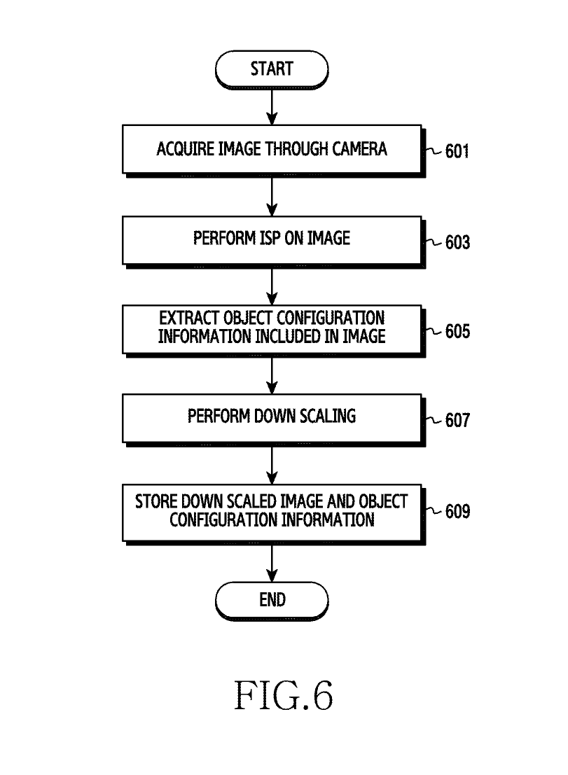

FIG. 6 is a flowchart illustrating an operation for converting an image acquired through a camera in an electronic device according to various embodiments of the present disclosure.

Referring to FIG. 6, in operation 601, the electronic device (for example, the electronic device 100 of FIG. 1 or the electronic device 301 of FIG. 3) may acquire an original image (for example, raw image) through a camera module (for example, the camera module 170).

In operation 603, the electronic device may perform ISP on the original image. For example, the electronic device may perform the ISP on the original image. The electronic device may perform color interpolation on the image signal-processed image.

In operation 605, the electronic device may extract configuration information (for example, edge information) on objects included in the image (for example, the original image or the image signal-processed image). Additionally, the electronic device may extract a depth map of the corresponding image.

In operation 607, the electronic device may down scale the image (for example, the original image or the image converted to extract the object configuration information). For example, the electronic device may reduce a size (for example, resolution) of the image in accordance with a resolution of the display 160.

In operation 609, the electronic device may store the down scaled image and the object configuration information on the corresponding image in a frame buffer (for example, the frame buffer 210). For example, the electronic device may encode at least one of the down scaled image and the object configuration information and store the down scaled image or the object configuration information in the frame buffer. For example, the electronic device may determine whether to encode the downscaled image based on the complexity of the down scaled image.

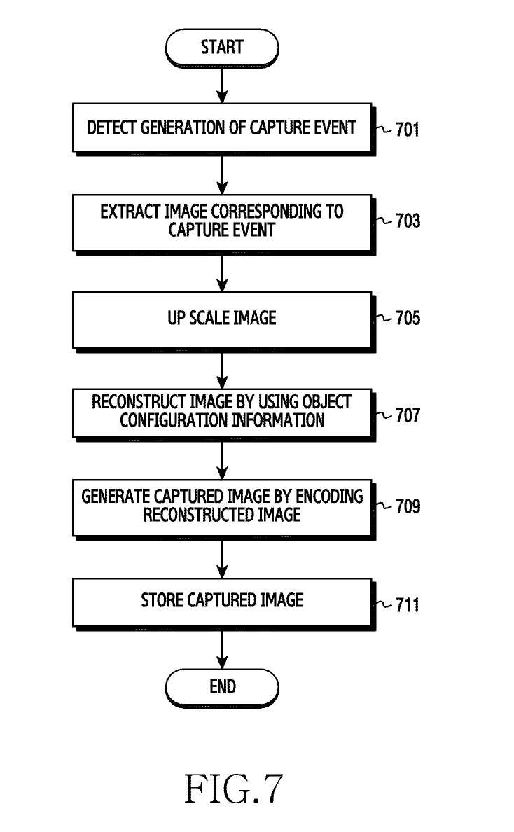

FIG. 7 is a flowchart illustrating an operation for generating a captured image in an electronic device according to various embodiments of the present disclosure.

Referring to FIG. 7, in operation 701, the electronic device (for example, the electronic device 100 of FIG. 1 or the electronic device 301 of FIG. 3) may detect the generation of a capture event. For example, the electronic device may identify whether an icon, a button, a menu, etc., to which the capture event is mapped, are selected based on input information detected through the input/output interface 150.

In operation 703, the electronic device may extract the image (for example, down scaled image) corresponding to the capture event among the images stored in a frame buffer. For example, among the images stored in the frame buffer, the electronic device may extract an image corresponding to a preview image displayed on the display 160 at a time point when the capture event is generated.

In operation 705, the electronic device may up scale the image corresponding to the capture event. For example, the electronic device may enlarge a size (for example, resolution) of the image corresponding to the capture event.

In operation 707, the electronic device may reconstruct the corresponding image by using the object configuration information on the image corresponding to the capture event and the up scaled image. For example, the electronic device may reconstruct the image by adding edge information on the corresponding image to the up scaled image.

In operation 709, the electronic device may generate a captured image by encoding the reconstructed image into a reference format (for example, JPEG, HEVC, H.264, or the like).

In operation 711, the electronic device may store the captured image in a memory (for example, the memory 130 of FIG. 1). Additionally, the electronic device may store the object configuration information such that the object configuration information is mapped to the corresponding captured image to perform additional image processing on the captured image. For example, the electronic device may add the object configuration information to an expanded field of the captured image and store the captured image.

In FIG. 7, the electronic device may up scale the down scaled image stored in the frame buffer and generate and store the captured image. Accordingly, when a display event of the captured image is generated, the electronic device may extract the captured image stored in the memory 130 and display the captured image on the display 160.

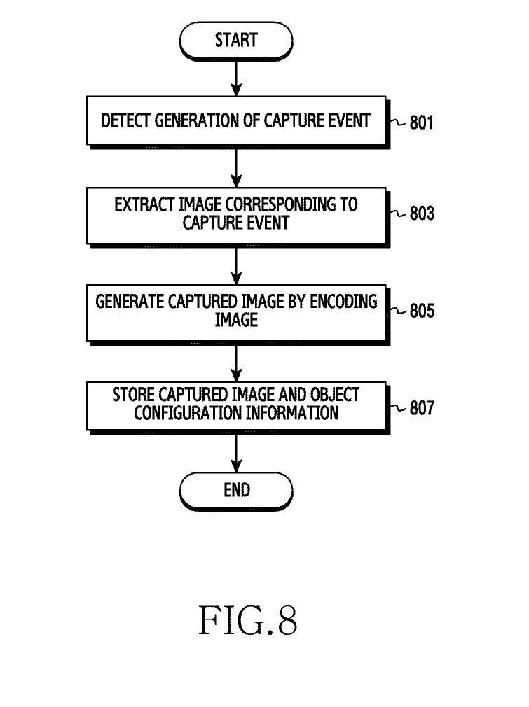

FIG. 8 is a flowchart illustrating an operation for generating a captured image in an electronic device according to various embodiments of the present disclosure.

Referring to FIG. 8, in operation 801, the electronic device (for example, the electronic device 100 of FIG. 1 or the electronic device 301 of FIG. 3) may detect the generation of a capture event. For example, the electronic device may identify whether an icon, a button, a menu, etc., to which the capture event is mapped, are selected based on input information detected through the input/output interface 150.

In operation 803, the electronic device may extract the image (for example, down scaled image) corresponding to the capture event among the images stored in a frame buffer. For example, among the images stored in the frame buffer, the electronic device may extract an image corresponding to a preview image displayed on the display 160 at a time point when the capture event is generated.

In operation 805, the electronic device may generate a captured image by encoding the image corresponding to the capture event into a reference format (for example, JPEG, HEVC, H.264, or the like).

In operation 807, the electronic device may store the captured image and object configuration information corresponding to the captured image in the memory (the memory 130 of FIG. 1). For example, the electronic device may add the object configuration information to an expanded field of the captured image and store the captured image.

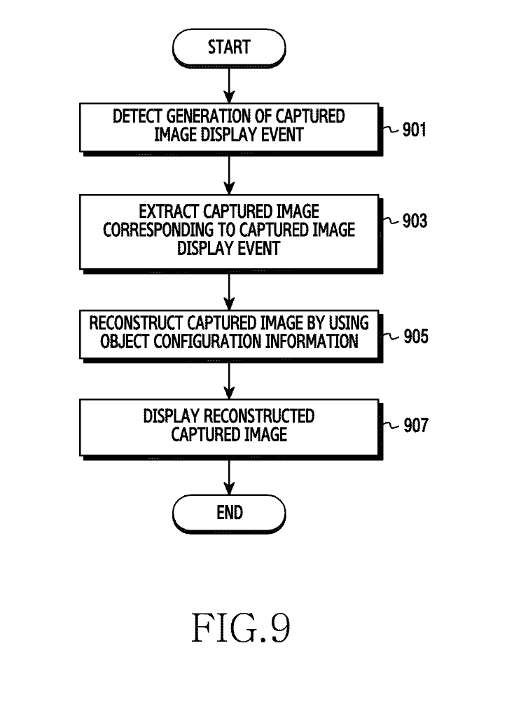

In FIG. 8, the electronic device may encode the down scaled image stored in the frame buffer and generate and store the captured image. Accordingly, when a display event of the captured image is generated as illustrated in FIG. 9, the electronic device may up scale the captured image stored in the memory 130 and display the captured image on the display 160.

FIG. 9 is a flowchart illustrating an operation for displaying a captured image in an electronic device according to various embodiments of the present disclosure.

Referring to FIG. 9, in operation 901, the electronic device (the electronic device 100 of FIG. 1 or the electronic device 301 of FIG. 3) may detect the generation of a captured image display event. For example, the electronic device may identify whether a captured image to be displayed on the display 160 is selected based on input information detected through the input/output interface 150.

In operation 903, the electronic device may extract a captured image (for example, down scaled captured image) corresponding to the captured image display event among the captured images stored in the memory (for example, the memory 130).

In operation 905, the electronic device may reconstruct the corresponding captured image by using the captured image corresponding to the captured image display event and object configuration information on the corresponding captured image. For example, the electronic device may reconstruct the image by adding edge information on the corresponding captured image to the captured image corresponding to the captured image display event.

In operation 907, the electronic device may display the reconstructed captured image on the display 160.

According to various embodiments of the present disclosure, a method of operating an electronic device may include acquiring an image, extracting object configuration information on the image, down scaling the image, and storing the down scaled image and the object configuration information.

According to various embodiments of the present disclosure, the method may further include performing ISP on the down scaled image after the down scaling of the image, wherein the storing the down scaled image and the object configuration information may include storing the image signal-processed image and the object configuration information.

According to various embodiments of the present disclosure, the method may further include performing ISP on the image before the extracting of the object configuration information, wherein the extracting of the object configuration information may include extracting object configuration information on the image signal-processed image.

According to various embodiments of the present disclosure, the object configuration information may include edge information, or edge information and a depth map.

According to various embodiments of the present disclosure, the storing of the down scaled image and the object configuration information may include determining whether to encode the down scaled image based on a complexity of the down scaled image, encoding the down scaled image and storing the encoded image in a buffer of the electronic device in response to the determination to encode the down scaled image, and storing the down scaled image in the buffer of the electronic device in response to the determination to not encode the down scaled image.

According to various embodiments of the present disclosure, the method may further include generating a captured image by using the stored down scaled image in response to a capture event.

According to various embodiments of the present disclosure, the generating of the captured image may include extracting an image corresponding to the capture event among the stored down scaled images in response to the capture event, up scaling the extracted image, reconstructing the image by using the up scaled image and object configuration information on the image corresponding to the capture event, generating a captured image by encoding the reconstructed image into a reference format, and storing the captured image.

According to various embodiments of the present disclosure, the storing of the captured image may include adding the object configuration information on the image corresponding to the capture event to an expanded field of the captured image and storing the captured image.

According to various embodiments of the present disclosure, the generating of the captured image may include, extracting an image corresponding to the capture event among the stored down scaled images in response to the capture event, generating a captured image by encoding the extracted image into a reference format, and storing the captured image and object configuration information on the captured image.

According to various embodiments of the present disclosure, the storing of the object configuration information on the captured image may include adding the object configuration information on the captured image to an expanded field of the captured image and storing the captured image.

According to various embodiments of the present disclosure, the method may further include extracting a captured image corresponding to a display event among the stored captured images stored in response to the display event, reconstructing the captured image by using the extracted captured image and object configuration information on the captured image, and displaying the reconstructed captured image on the display.

An electronic device and a method according to various embodiments can generate a captured image by using, for example, a down scaled image (raw image), thereby reducing image processing load and consumption of memory resources due to image storage.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a program module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (for example, a magnetic tape), optical media (for example, a compact disc read only memory (CD-ROM) and a digital versatile disc (DVD)), magneto-optical media (for example, a floptical disk), a hardware device (for example, a read only memory (ROM), a random access memory (RAM), a flash memory), and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
acquiring an image;
extracting object configuration information on the image;
down scaling the image; and
storing the down scaled image and the object configuration information.

2. The method of claim 1, further comprising performing image signal processing (ISP) on the down scaled image after the down scaling of the image,
wherein the storing of the down scaled image and the object configuration information comprises storing the image signal-processed image and the object configuration information.

3. The method of claim 1, further comprising performing image signal processing (ISP) on the image before the extracting of the object configuration information,
wherein the extracting of the object configuration information comprises extracting object configuration information on the image signal-processed image.

4. The method of claim 1, wherein the object configuration information includes at least one of edge information or a depth map.

5. The method of claim 1, wherein the storing of the down scaled image and the object configuration information comprises:
determining whether to encode the down scaled image based on a complexity of the down scaled image;
encoding the down scaled image and storing the encoded image in a buffer of the electronic device in response to the determination to encode the down scaled image; and
storing the down scaled image in the buffer of the electronic device in response to the determination to not encode the down scaled image.

6. The method of claim 1, further comprising generating a captured image by using the stored down scaled image in response to a capture event.

7. The method of claim 6, wherein the generating of the captured image comprises:
extracting an image corresponding to the capture event among the stored down scaled images in response to the capture event;
up scaling the extracted image;
reconstructing the image by using the up scaled image and object configuration information on the image corresponding to the capture event;
generating a captured image by encoding the reconstructed image into a reference format; and
storing the captured image.

8. The method of claim 7, wherein the storing of the captured image comprises adding the object configuration information on the image corresponding to the capture event to an expanded field of the captured image and storing the captured image.

9. The method of claim 6, wherein the generating of the captured image comprises:
extracting an image corresponding to the capture event among the stored down scaled images in response to the capture event;
generating a captured image by encoding the extracted image into a reference format; and
storing the captured image and object configuration information on the captured image.

10. The method of claim 9, further comprising:
extracting a captured image corresponding to a display event among the stored captured images in response to the display event;
reconstructing the captured image by using the extracted captured image and object configuration information on the captured image; and
displaying the reconstructed captured image on the display.

11. The method of claim 1, wherein the acquiring of the image comprises receiving the image from an external device in at least one of a YUV and RGB format.

12. An electronic device comprising:
a memory configured to store an image and information related to the image; and
a processor configured to:
acquire the image,
extract object configuration information on the image,
down scale the image, and
store the down scaled image and the object configuration information in the memory.

13. The electronic device of claim 12, wherein the processor is further configured to:
perform image signal processing (ISP) on the down scaled image, and
store the image signal-processed down scaled image and the object configuration information in the memory.

14. The electronic device of claim 12, wherein the processor is further configured to:
perform ISP on the image, and
extract object configuration information on the image signal-processed image.

15. The electronic device of claim 12, wherein the processor is further configured to extract edge information on the image or object configuration information including edge information and a depth map.

16. The electronic device of claim 12, wherein the processor is further configured to:
determine whether to encode the down scaled image based on a complexity of the down scaled image,
encode the down scaled image and store the encoded image in a buffer of the memory in response to the determination to encode the down scaled image, and
store the down scaled image in the buffer of the electronic device in response to the determination to not encode the down scaled image.

17. The electronic device of claim 12, wherein the processor is further configured to generate a captured image by using the stored down scaled image in response to a capture event.

18. The electronic device of claim 17, wherein the processor is further configured to:
extract an image corresponding to the capture event among the down scaled images stored in the memory in response to the capture event,
up scale the extracted image,
reconstruct the image by using the up scaled image and object configuration information on the image corresponding to the capture event,
generate a captured image by encoding the reconstructed image into a reference format, and
store the captured image in the memory.

19. The electronic device of claim 18, wherein the memory is further configured to:
add the object configuration information on the image corresponding to the capture event to an expanded field of the captured image, and
store the captured image.

20. The electronic device of claim 17, wherein the processor is further configured to:
extract an image corresponding to the capture event among the stored down scaled images in response to the capture event,
generate a captured image by encoding the extracted image into a reference format, and
store the captured image and object configuration information on the captured image in the memory.

21. The electronic device of claim 20, further comprising a display configured to display information,
wherein the processor is further configured to:
extract a captured image corresponding to a display event among the captured images stored in the memory in response to the display event,
reconstruct the captured image by using the extracted captured image and object configuration information on the captured image, and
control the display to display the reconstructed captured image on the display.

22. The electronic device of claim 12, wherein the processor is further configured to acquire the image by receiving the image from an external device in at least one of a YUV and RGB format.
